(19) United States
(12) Patent Application Publication
(10) Pub. No.: US 2010/0252196 A1
(43) Pub. Date: Oct. 7, 2010

(54) BAG FOR HERMETICALLY ENCLOSING AN INFLATABLE LIFERAFT

(75) Inventor: Nikhil Garde, Esbjerg (DK)

Correspondence Address: NIXON & VANDERHYE, PC, 901 NORTH GLEBE ROAD, 11TH FLOOR, ARLINGTON, VA, 22203, US

(73) Assignee: VIKING LIFE-SAVING EQUIPMENT A/S, Esbjerg V (DK)

(21) Appl. No.: 12/734,564

(22) PCT Filed: Nov. 9, 2007
(86) PCT No.: PCT/IB2007/003426

§ 371 Date: May 10, 2010

(51) Int. Cl. B65D 33/00; B32B 43/00

(52) U.S. Cl. 156/344; 383/205

(57) ABSTRACT

The present invention relates to a bag (1) for hermetically enclosing an inflatable liferaft; the bag is made of an impermeable material and comprises an outer side (6) and an inner side (8); the bag further comprises an opening. Furthermore, said opening is a slit (51) in the impermeable material closed by a peelable layer (2) so that the bag substantially maintains its hermetical property.

### TECHNICAL FIELD OF THE INVENTION

The present invention relates to a bag for hermetically enclosing an inflatable liferaft; the bag is made of an impermeable material and comprises an outer side and an inner side; the bag further comprises an opening.

The term “liferaft” is in this context to be construed as an inflatable liferaft with or without a canopy, an inflatable dinghy, an inflatable platform or the like.

### BACKGROUND ART

Inflatable liferafts enclosed in the self-opening containers are well known and are used as mandatory life-saving equipment throughout the world on almost any commercial ship and vessel of a given size.

In this context, the inflatable liferaft in its container can be considered to be permanently secured to the ship and is normally only dismounted when the inflatable liferaft is to be serviced at a land-based service-station, e.g. once yearly, or when other types of maintenance takes place on the ship.

Indeed, when the inflatable liferaft is deployed in an emergency situation the container is released from its mounting means and either dropped into the water where the container will open and the liferaft inflate or lowered into the water by means of a davit or crane (either in inflated or deflate state). The typical size for such a permanently mounted liferaft may be for 4 to 150 persons.

The inflatable liferafts are stored on the deck of a ship or vessel, which may expose the inflatable liferafts for different environmental changes such as wind, sun, salt, water and/or moisture. The outer container, which houses the inflatable liferaft, is capable of protecting the inflatable liferaft against the mechanical actions, however, it is not suitable for protecting the inflatable liferaft against for instance moisture. The reason for this is that in the prior art it has not yet been possible to provide a secure sealing of the container.

When the inflatable liferaft is exposed to moisture, it may have the result that different material of the inflatable liferaft will start to disintegrate or corrode, which may reduce the life of the inflatable liferaft.

Furthermore, moisture, especially moisture containing salt, has corrosion effect on the different metal parts or attachments mounted on the inflatable liferafts. For protecting the inflatable liferaft against the outer environment it is known to place the liferaft in a sealed bag.

In situations where elements which are connected to the liferaft, but should be accessible from the outside of the bag, are necessary, for instance the release means for the inflation of the liferaft or mooring means, or when access to the interior of the bag is necessary, for instance in circumstances where a lifting strap is used for lowering the liferaft into the water, some disadvantages in the prior art have been observed in relation to keeping the bag completely sealed, especially around the lines going through the bag, as well as in relation to means assisting in and controlling the rupturing of the bag.

Several solutions have been suggested for solving the disadvantages in the prior art bags. For instance is it known to seal with the use of rubber mass or similar masses around a line lead-in through the bag, however, this is a time-consuming process and it is difficult to control the sealing around the line and thereby the tightness of the bag. The same prior art solution suggests a technique to control the rupture of the bag. In this solution, the line is separated into two lines, which are glued to the inside of the bag in different directions. At the lead-in a plate element, having a groove for the lines, is glued to the inside of the bag for controlling the starting direction of the rupture of the bag as well as for minimising the risk for the bag wrinkle around the lead-in. Even though the solution functions well, it still uses the rubber sealing of the lead-in and its disadvantages, and it is time- as well as material-consuming.

Also in not directly connected techniques, solutions for readily opening a bag is known, as for instance in GB 804,559, which discloses a tear strip secured to the inner side of the bag. GB 804,559 does not relate to any issues regarding sealing of the tear strip. U.S. Pat. No. 5,409,115 discloses opening techniques of a bag without the use of incorporated perforation lines in the bag or other helping means, such as tear strips. Instead it uses a tear-off tongue placed in connection with a sealing seam, which is pulled when the bag is to be opened; however, it is difficult to control a rupture over a sealing seam and at the same time secure that the seam is strong and tight.

### SUMMARY OF THE INVENTION

An object of the present invention is to wholly or partly overcome the above disadvantages and drawbacks of the prior art. More specifically, it is an object to provide a bag which is hermetically sealed.

It is also an object of the present invention to provide a bag which easily may be opened and torn, even in stressed life-saving situations.

Another object of the present invention is to provide a bag which can be torn even in circumstances where it wrinkles.

The above objects, together with numerous other objects, advantages and features, which will become evident from the below description, are accomplished by a solution in accordance with the present invention by said opening being a slit in the impermeable material closed by a peelable layer so that the bag substantially maintains its hermetical property.

Hereby a bag is obtained which is hermetically sealed by the use of the peelable layer and thereby closes the bag and the enclosed inflatable liferaft complete off from the surrounding environments. The bag is both water-and air-tight. Furthermore, by incorporating the slit in the material of the bag, it is obtained that a tear strip may be started without the use of any weakening line in the material.

The material of the bag may be without tear lines, perforations, tear strips or similar integrated tear helping means

According to the invention, the slit may be positioned in a sealing seamless area of the bag.

Furthermore, the slit may be made by cutting and removing material from the bag.

According to the invention, the shape of the slit may be A-formed, V-formed, triangular, rectangular, preferably A-formed.

Also according to the invention, two or more slits may be arranged with a predetermined distance and in a predetermined direction. Hereby is obtained that if the first slit malfunctions of some reason the next slit will take over and start the tear strip during use.

In a preferred embodiment according to the invention, a first strip may be arranged in connection with the peelable layer so that it is accessible from the outer side of the bag, and a second strip may be arranged in connection with the peelable layer and extend from the slit into the bag, said second strip being connected to the liferaft or a part or parts of the liferaft inside the bag so that when the first strip is pulled, it peels the peelable layer so that access and connection to the second strip is obtained, whereby the liferaft or a part or parts of the liferaft, which is connected to the second strip, may be pulled out of the bag by continuous pulling of the first strip.

According to the invention, the configuration of the slit, the position of the peelable layer, the first and second strip and the pull direction of the first strip may control the tear or break direction of the material of the bag.

In addition, the second strip may be adhered to the inner side of the bag in a predetermined direction from the slit, so that the tear or break direction of the material is controlled.

According to the invention, the first strip may be connected to an edge and/or an outer side of the peelable layer.

Also according to the invention, the first strip may be connected to the inner side of the peelable layer.

According to the invention, the second strip may be connected to the first strip.

Furthermore, the first and second strip may be in one piece.

According to the invention, the first strip may be integrated with the peelable layer, whereby an expedient embodiment of the present invention is obtained.

According to the invention, the material of the bag may be a composite comprising two or more layers.

In addition, the composite may comprise at least three layers, an outer layer made of polyester (PET), an intermediate layer made of aluminium and an inner layer made of polyethylene (PE).

According to the invention, the material of the bag may possess tearable properties.

Furthermore, the peelable layer may be made of the same material as the bag.

According to the invention, the bag may be torn by a force lower than 150 N, preferably below 30 N.

The invention also relates to a container for housing an inflatable liferaft, said liferaft being enclosed in a bag according to any one of the claims 1 to 19.

The invention furthermore relates to a use of the bag for providing access to the interior of the bag so that a lifting strap for the liferaft may be pulled out of the bag or the release means for the inflating of the liferaft may be pulled out of the bag.

Additionally, the invention relates to a method for providing access to a lifting strap and/or release means of an inflatable liferaft enclosed hermetically inside a bag according to any one of the claims 1 to 19, said method comprising the steps of:

pulling a first strip so that a peelable layer is peeled,

continuous pulling of the first strip so that a second strip, which is connected to the peelable layer, is pulled out of the bag, and

further pulling of the first strip so that the second strip tears or breaks the material of the bag so that the lifting strap and/or release means is pulled out of the bag.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows schematically a part of a bag according to the invention with a peelable layer,

FIGS. 2-5 show different embodiments of the shape of a slit according to the invention, and

FIGS. 6-9 show in cross-sectional views different embodiments of the peelable layer adhered to the outer side of the bag as well as different positions of the strips.

All the figures are highly schematic and not necessarily to scale, and they show only parts which are necessary in order to elucidate the invention, other parts being omitted or merely suggested.

### DESCRIPTION OF PREFERRED EMBODIMENTS

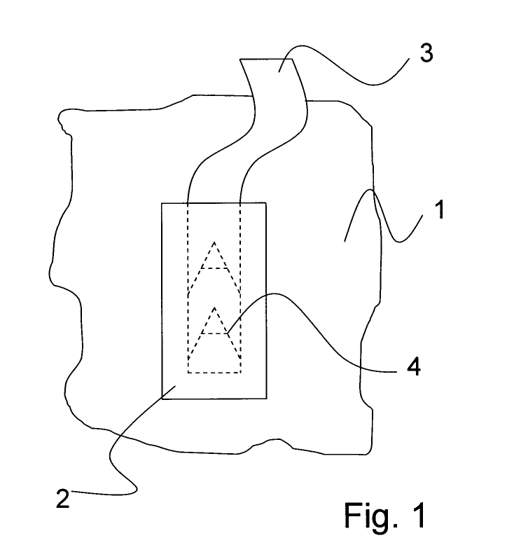

FIG. 1 shows a part of a bag 1 according to the invention. On the outer side of the bag 1, a peelable layer 2 is arranged so that the bag is hermetically sealed and is air- and watertight. In this embodiment, a first strip 3 is connected to the inner side of the peelable layer 2, which will be further explained in connection with FIG. 7 below. The peelable layer 2 covers in this embodiment two slits 4 (shown in dotted lines), which have the shape as an A.

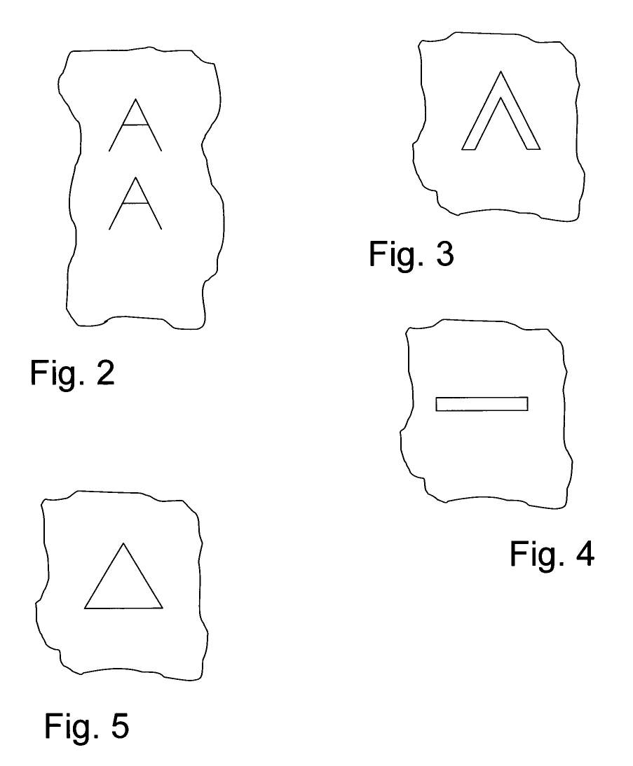

FIGS. 2 to 5 all show different embodiments of the shape of the slit according to the invention. In FIG. 2, a preferred embodiment of the invention is shown, wherein the slit has a shape as an A. In this embodiment, two slits are arranged with a predetermined distance and in a predetermined direction so that the tear and break direction of the material may be controlled. Within the inventive idea, a plurality of slits may be arranged, said slits all being covered by the peelable layer. FIGS. 3 to 5 show the slit having a V-form, a rectangular form and triangular form, respectively. The slit may have many other configurations within the inventive idea. The slits may advantageously be made by cutting and removing material from the bag.

Furthermore, the slit or slits are preferably placed in an area of the bag, which is seamless, so that no seam will influence on the tearing and breaking of the material, whereby an easy handling and control of the tearing of the bag is facilitated. Advantageously, the bag may be torn by a force lower than 150 N, preferably below 30 N.

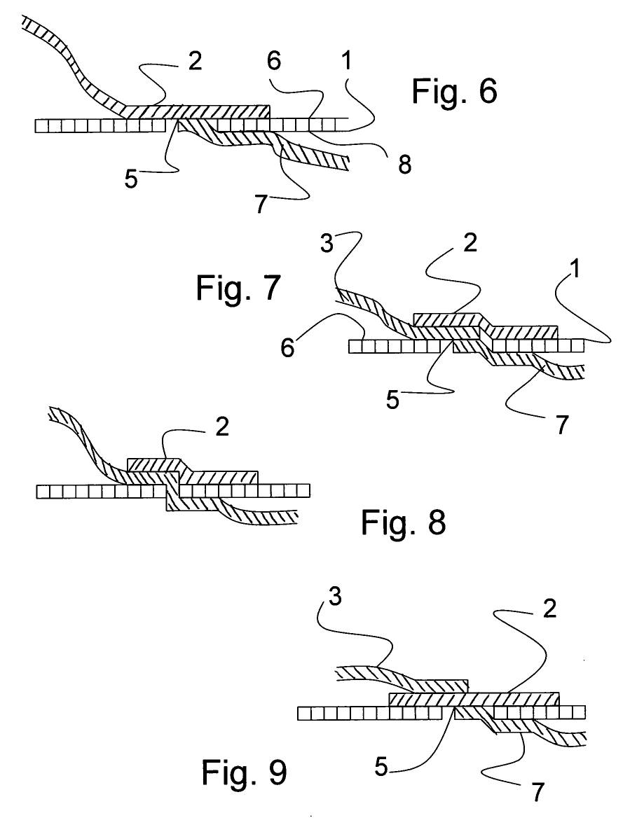

FIG. 6 shows in a cross-sectional view the first strip integrated with the peelable layer 2. Said peelable layer 2 covers the slit 5 and is adhered to the surrounding area of the slit on the outer side 6 of the bag 1 so that the connection is hermetically closed. A second strip 7 is connected to the peelable layer 2 through the slit 5. Said second strip 7 may be adhered to the peelable layer and/or to the inner side 8 of the bag 1.

FIG. 7 shows in same way as FIG. 7 another embodiment of the present invention, wherein the first strip 3 is connected to the inner side of the peelable layer 2. Said peelable layer 2 as well as the first strip 3 completely covers the slit 5. For securing complete sealing of the closure of the slit 5, the end of the first strip 3 being arranged below the peelable layer 2 may also be adhered to the outer side 6 of the bag 1. In this embodiment, the second strip 7 is connected directly to the first strip 3 through the slit 5.

In FIG. 8 the first and second strip is shown as connected into one piece, for instance being endless, and is covered by a peelable layer 2 in same way as described in connection with FIG. 7.

FIG. 9 shows the first strip 3 connected to the outer side of the peelable layer 2. The second strip 7 is connected to the peelable layer 2 via the slit 5. Said peelable layer 2 completely covers the slit 5 and secures that the bag 1 maintains it's hermetically properties, i.e. being air-and watertight. Within the inventive idea, the first strip may also be connected to an edge of the peelable layer.

Furthermore, the material of the bag may be a composite comprising two or more layers so that the material may be custom-made to exhibit predetermined properties. For instance, the composite may comprise at least three layers, an outer layer made of polyester (PET), an intermediate layer made of aluminium and an inner layer made of polyethylene (PE). The PET layer secures that the material may withstand high temperatures. Furthermore, it provides impermeability to the material. The aluminium layer provides a barrier against moisture as well as against aggressive gases. The PE layer secures that welding of the aluminium layer is possible. Within the inventive idea the material may comprise additional layers, for instance an extra reinforcement layer may be arranged between the outer layer and the intermediate layer, and an antistatic or reinforcement layer in for instance polyamide (PA) may be arranged between the intermediate layer and the inner layer.

Advantageously, the composition of the material may be chosen such as the material of the bag may possess tearable properties, which will facilitate the tearing and/or breaking of the bag.

The present invention also relates to a method for providing access to a lifting strap and/or release means of an inflatable liferaft enclosed hermetically inside a bag. Said bag comprises the features as described above. Said method comprises the steps of:

pulling a first strip so that a peelable layer is peeled,

continuous pulling of the first strip so that a second strip, which is connected to the peelable layer, is being pulled out of the bag, and

further pulling of the first strip so that the second strip tears or breaks the material of the bag so that the lifting strap and/or release means is pulled out of the bag.

Hereby an expedient method for tearing or breaking a bag is obtained, whereby easy handling of the rupture of the bag is facilitated, especially in stressed life-saving situations.

Although the invention above has been described in connection with preferred embodiments of the invention, it will be evident for a person skilled in the art that several modifications are conceivable without departing from the invention as defined by the following claims.

1. A bag (1) for hermetically enclosing an inflatable liferaft, the bag (1) is made of an impermeable material and comprises an outer side (6) and an inner side (8); the bag (1) further comprises an opening, characterized in that, said opening is a slit (5) in the impermeable material closed by a peelable layer (2) so that the bag (1) substantially maintains its hermetical property.

2. A bag (1) according to claim 1, wherein the material of the bag is without tear lines, perforations, tear strips or similar integrated tear helping means.

3. A bag (1) according to claim 1, wherein the slit (5) is positioned in a sealing seamless area of the bag (1).

4. A bag (1) according to claim 1, wherein the slit (5) is made by cutting and removing material from the bag (1).

5. A bag (1) according to claim 1, wherein the shape of the slit (5) is A-formed, V-formed, triangular, rectangular, preferably A-formed.

6. A bag (1) according to claim 1, wherein two or more slits (5) are arranged with a predetermined distance and in a predetermined direction.

7. A bag (1) according to claim 1, wherein a first strip (3) is arranged in connection with the peelable layer (2) so that it is accessible from the outer side (6) of the bag (1), and a second strip (7) is arranged in connection with the peelable layer (2) and extends from the slit (5) into the bag (1), said second strip (7) being connected to the liferaft or a part or parts of the liferaft inside the bag (1) so that when the first strip (3) is being pulled it peels the peelable layer (2) so that access and connection to the second strip (7) is obtained, whereby the liferaft or a part or parts of the liferaft, which is connected to the second strip (7), may be pulled out of the bag (1) by continuous pulling of the first strip (3).

8. A bag (1) according to claim 7, wherein the configuration of the slit (5), the position of the peelable layer (2), the first (3) and second (7) strip and the pull direction of the first strip (3) control the tear or break direction of the material of the bag (1).

9. A bag (1) according to claim 7, wherein the second strip (7) is adhered to the inner side (8) of the bag (1) in a predetermined direction from the slit (5).

10. A bag (1) according to claim 7, wherein the first strip (3) is connected to an edge and/or an outer side of the peelable layer (2).

11. A bag (1) according to claim 7, wherein the first strip (3) is connected to the inner side of the peelable layer (2).

12. A bag (1) according to claim 7, wherein the second strip (7) is connected to the first strip (3).

13. A bag (1) according to claim 7, wherein the first and second strip are in one piece.

14. A bag (1) according to claim 7, wherein the first strip (3) is integrated with the peelable layer (2).

15. A bag (1) according to claim 1, wherein the material of the bag (1) is a composite comprising two or more layers.

16. A bag (1) according to claim 15, wherein the composite comprises at least three layers, an outer layer made of polyester (PET), an intermediate layer made of aluminium and an inner layer made of polyethylene (PE).

17. A bag (1) according to claim 15, wherein the material of the bag (1) possesses tearable properties.

18. A bag (1) according to claim 15, wherein the peelable layer (2) is made of the same material as the bag.

19. A bag (1) according to claim 1, wherein the bag is torn by a force lower than 150 N, preferably below 30 N.

20. A container for housing an inflatable liferaft, characterised in the liferaft being enclosed in a bag (1) according to claim 1.

21. Use of the bag (1) according to claim 1 for providing access to the interior of the bag so that a lifting strap for the liferaft may be pulled out of the bag (1) or the release means for the inflating of the liferaft may be pulled out of the bag (1).

22. A method for providing access to a lifting strap and/or release means of an inflatable liferaft enclosed hermetically inside a bag (1) according to claim 1, comprising the steps of:
pulling a first strip (3) so that a peelable layer (2) is peeled,
continuous pulling of the first strip (3) so that a second strip (7), which is connected to the peelable layer (2), is pulled out of the bag (1), and
further pulling of the first strip (3) so that the second strip (7) tears or breaks the material of the bag (1) so that the lifting strap and/or release means is pulled out of the bag (1).
